(19) United States
(12) Patent Application Publication
(10) Pub. No.: US 2022/0212385 A1
(43) Pub. Date: Jul. 7, 2022

(54) MANUFACTURING METHOD AND INJECTION MOLDING SYSTEM

(71) Applicant: Canon Virginia, Inc., Newport News, VA (US)

(72) Inventors: Koki Kodaira, Tokyo (JP); Yuichi Yanahara, Moriyama (JP)

(21) Appl. No.: 17/611,522

(22) PCT Filed: May 13, 2020
(86) PCT No.: PCT/US20/32728

§ 371 Date: Nov. 15, 2021

Related U.S. Application Data
(60) Provisional application No. 62/849,482, filed on May 17, 2019.

(51) Int. Cl. B29C 45/42; B29C 45/73; B29C 45/17; B29C 45/04

(52) U.S. Cl. CPC B29C 45/4225; B29C 45/0416; B29C 45/1756; B29C 45/73

(57) ABSTRACT

Manufacturing a molded part using one injection molding machine while changing between multiple molds includes performing, at a molding operation position in the injection molding machine, clamping, injection, and dwelling of a mold, conveying the mold from the molding operation position and performing a process of cooling the mold at a position different from the molding operation position, conveying the mold to the molding operation position, opening the mold, and ejecting a molded part from the mold, wherein, before performing the first step for a first mold, a molded part previously ejected from a second mold is placed into the first mold that has been opened.

### CROSS-REFERENCE TO RELATED APPLICATION

This application claims the benefit of U.S. Provisional Application 62/849,482, which was filed on May 17, 2019.

### FIELD

The present disclosure relates to an injection molding system.

### BACKGROUND

In the manufacturing of molded parts by an injection molding machine, an injection process of filling a resin into a mold after clamping the mold, a dwelling process of pressing the resin into the mold at a high pressure in order to compensate for a volume decrease due to solidification of the resin, a cooling process of keeping the molded part in the mold until the resin is solidified, and an ejecting process of ejecting the molded part from the mold are repeatedly performed.

In the above-described molding approach, a method that uses two molds with one injection molding machine in order to enhance productivity has been proposed. For example, WE 2018/0009146/Japanese patent publication No. 2018-001738/VN20160002505 are seen to discuss a system in which conveying devices 3A and 3B are arranged on both sides of an injection molding machine 2. In this system, molded parts are manufactured while alternating a plurality of molds by the conveying devices 3A and 3B for the one injection molding machine 2. FIGS. 1-4 illustrate an injection molding system of US 2018/0009146/Japanese patent publication No. 2018-001738/VN20160002505.

Japanese patent publication No. H7-119012 discloses a system in which molded part ejecting apparatuses are arranged on both sides of an injection molding machine. In this system, in the injection molding machine, an injection process and a dwelling process can be performed on one mold, and a cooling process and an ejecting process can be performed by the molded part ejecting apparatus outside the injection molding machine on another mold. The molding operation proceeds while changing (alternating) the two molds between the injection molding machine and the molded part ejecting apparatus.

Generally, a mold is manufactured with a metal such as a steel material and can reach weights from several kilograms to several hundred kilograms. For a mold, to manufacture a molded part without a problem such as a burr and whose dimensional precision is high, molded parts are manufactured at high dimensional precision, and combined, and therefore sufficient precision is required from the mold opening/closing mechanism. Accordingly, the opening/closing mechanism is often expensive.

In the system of Japanese patent publication No. H7-119012, because the molded part is ejected outside the injection molding machine, it is necessary to provide a mold opening/closing mechanism for each ejecting apparatus. It is also necessary to provide a molded part ejecting mechanism for each ejecting apparatus. Accordingly, multiple mold opening/closing mechanisms and molded part ejecting mechanisms become necessary, and the cost of the system as a whole becomes expensive.

While the system of Japanese patent publication No. H7-119012 can enhance productivity compared to normal molding by executing the cooling process both inside and outside the injection molding machine, there is room for further improvement. For example, if the times for processes inside and outside the injection molding machine are respectively assigned to be half that of the overall molding process, productivity will be maximized.

Japanese patent publication No. H10-180797 discloses a technology about insert molding. Injection molding is performed after transferring a part into the mold, and the insert molding technology that performs integral molding of the relevant part and resin is widely known. However many parts to be inserted are prepared beforehand.

Until now, a technology that performs insert molding while alternating multiple molds was unknown. The equipment configuration that considers the productivity when performing insert molding while exchanging molds was not sufficiently considered.

### SUMMARY

According to at least one aspect of the present disclosure, a method for manufacturing a molded part using one injection molding machine while changing between multiple molds includes a first step of performing, at a molding operation position in the injection molding machine, clamping, injection, and dwelling of a mold, a second step of conveying the mold from the molding operation position and performing a process of cooling the mold at a position different from the molding operation position, and a third step of conveying the mold to the molding operation position, opening the mold, and ejecting a molded part, wherein, before performing the first step for a first mold, a molded part previously ejected from a second mold is placed into the first mold opened in the third step.

This and other embodiments, features, and advantages of the present disclosure will become apparent upon reading the following detailed description of exemplary embodiments of the present disclosure, when taken in conjunction with the appended drawings, and provided claims.

### BRIEF DESCRIPTION OF DRAWINGS

FIG. 1 is a plan view of an injection molding system according to an exemplary embodiment.

FIG. 2 is a side view of the injection molding machine.

FIG. 3 is an end view of a stationary platen, and a figure viewing from the arrow direction of the I-I line in FIG. 2.

FIG. 4 is a partial perspective view describing the configuration of the periphery of the molding operation position.

FIG. 5 is a flowchart illustrating an example of a control method of a molding system executed by the controller.

FIG. 6 illustrates details of the chuck.

FIG. 7 is an illustrative view of a chuck plate of another exemplary embodiment.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF EXEMPLARY EMBODIMENTS

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

With reference to the drawings, the arrow symbols X and Y in each Figure indicate horizontal directions that are orthogonal to each other, and the arrow symbol Z indicates a vertical (upright) direction with respect to the ground.

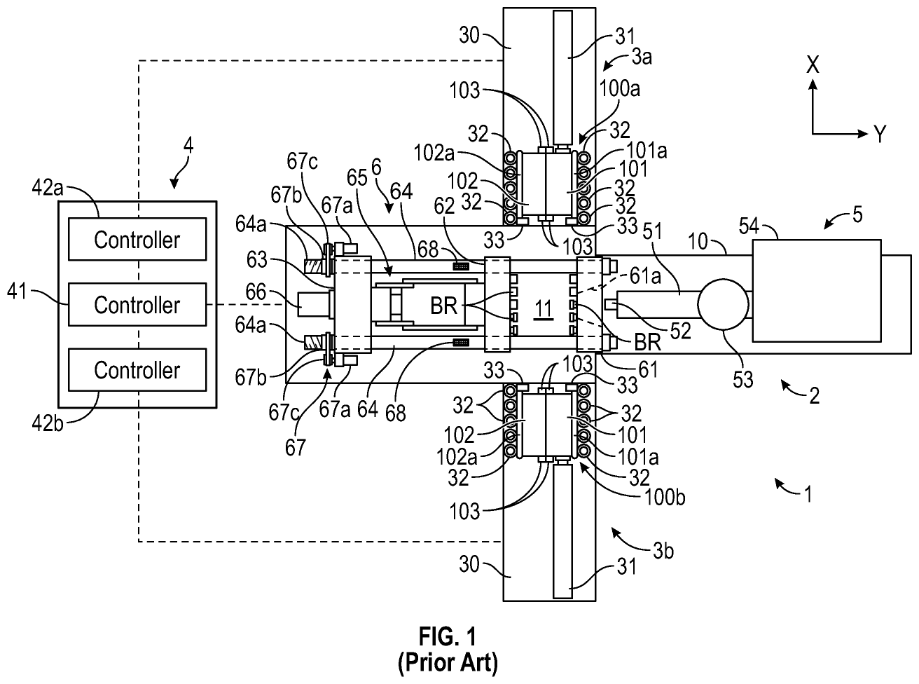

FIGS. 1-4 illustrate injection molding system 1 of US 2018/0009146/Japanese patent publication No. 2018-001738/VN20160002505 and are being provided herein for information/description purposes only.

The injection molding system 1 includes an injection molding machine 2, conveying machines 3A and 3B, and a control apparatus 4. The injection molding system 1 manufactures a molded part while alternating a plurality of molds using the conveying machines 3A and 3B for the one injection molding machine 2. Two molds, 100A and 100B are used.

The mold 100A/100B is a pair of a fixed mold 101 and a movable mold 102, which is opened/closed in relation to the fixed mold 101. The molded part is molded by injecting a molten resin into a cavity formed between the fixed mold 101 and the movable mold 102. Clamping plates 101a and 102a are respectively fixed to the fixed mold 101 and the movable mold 102. The clamping plates 101a and 102a are used to lock the mold 100A/100B to a molding operation position 11 (mold clamping position) of the injection molding machine.

For the mold 100A/100B, a self-closing unit 103 is provided for maintaining a closed state between the fixed mold 101 and the movable mold 102. The self-closing unit 103 enables preventing the mold 100A/100B from opening after unloading the mold 100A/100B from the injection molding machine 2. The self-closing unit 103 maintains the mold 100A/100B in a closed state using a magnetic force. The self-closing unit 103 located at a plurality of locations along opposing surfaces of the fixed mold 101 and the movable mold 102. The self-closing unit 103 is a combination of an element on the side of the fixed mold 101 and an element on the side of the movable mold 102. For the self-closing unit 103, typically two or more pair are installed for one of the molds 100A and 100B.

A conveying machine 3A loads and unloads the mold 100A onto/from the molding operation position 11 of the injection molding machine 2. A conveying machine 3B loads and unloads the mold 100B onto/from the molding operation position 11. The conveying machine 3A, the injection molding machine 2, and the conveying machine 3B are arranged to be lined up in this order in the X-axis direction. In other words, the conveying machine 3A and the conveying machine 3B are arranged laterally with respect to the injection molding machine 2 to sandwich the injection molding machine 2 in the X-axis direction. The conveying machines 3A and 3B are arranged to face each other, and the conveying machine 3A is arranged on one side laterally of the injection molding machine 2, and the conveying machine 3B is arranged on the other side respectively adjacent. The molding operation position 11 is positioned between the conveying machine 3A and the conveying machine 3B. The conveying machines 3A and 3B respectively include a frame 30, a conveyance unit 31, a plurality of rollers 32, and a plurality of rollers 33.

The frame 30 is a skeleton of the conveying machine 3A and 3B, and supports the conveyance unit 31, and the pluralities of rollers 32 and 33. The conveyance unit 31 is an apparatus that moves the mold 100A/100B back and forth in the X-axis direction, and that removes and inserts the mold 100A/100B in relation to the molding operation position 11.

The conveyance unit 31 is an electrically driven cylinder with a motor as a driving source, and includes a rod that moves forward/backward in relation to the cylinder. The cylinder is fixed to the frame 30, and the fixed mold 101 is fixed to the edge portion of the rod. For the conveyance unit 31 both a fluid actuator and an electric actuator can be used, where the electric actuator can provide better precision of control of the position or the speed when conveying the mold 100A/100B. The fluid actuator can be an oil hydraulic cylinder, or an air cylinder, for example. The electric actuator can, in addition to an electrically driven cylinder, be a rack-and-pinion mechanism with a motor as the driving source, a ball screw mechanism with a motor as the driving source, or the like.

The conveyance unit 31 is arranged independently for each of the conveying machines 3A and 3B. However, a common support member that supports the molds 100A and 100B can be used, and a single common conveyance unit 31 can be arranged for this support member. A case where the conveyance unit 31 is arranged independently for each of the conveying machines 3A and 3B enables handling cases where a movement strokes differ between the mold 100A and the mold 100B when conveying. For example, a case in which molds cannot be conveyed simultaneously since the widths of the molds (the width in the X direction) differ or the thickness of the molds (the width in the Y direction) differ.

The plurality rollers 32 configure a row of rollers arranged in the X-axis direction, where two rows are configured separated in the Y-axis direction. The plurality of rollers 32 rotate around the axis of revolution in the Z-axis direction, and guide movement in the X-axis direction of the mold 100A/100B contacting the side surfaces of the mold 100A/100B (the side surfaces of the clamping plates 101a and 102a) and supporting the mold 100A/100B from the side. The plurality rollers 33 configure a row of rollers arranged in the X-axis direction, where two rows are configured separated in the Y-axis direction. The plurality of rollers 33 rotate around the axis of revolution in the Y direction, and cause movement in the X direction of the mold 100A/100B to be smooth, supporting the bottom surfaces of the mold 100A/100B (the bottom surfaces of the clamping plates 101a and 102a) and supporting the mold 100A/100B from below.

The control apparatus 4 includes a controller 41 for controlling the injection molding machine 2, a controller 42A for controlling the conveying machine 3A, and a controller 42B for controlling the conveying machine 3B. Each of the controllers 41, 42A and 42B includes, for example, a processor such as a CPU, a RAM, a ROM, a storage device such as a hard disk, and interfaces connected to sensors or actuators (not illustrated). The processor executes programs stored in the storage device. An example of a program (control) that the controller 41 executes is described below. The controller 41 is communicably connected with the controllers 42A and 42B, and provides instructions related to the conveyance of the mold 100A/100B to the controllers 42A and 42B. The controllers 42A and 42B, if loading and unloading of the mold 100A/100B terminates, transmit a signal for operation completion to the controller 41. In addition, the controllers 42A and 42B transmit an emergency stop signal at a time of an abnormal occurrence to the controller 41.

A controller is arranged for each of the injection molding machine 2, the conveying machine 3A, and the conveying machine 3B, but one controller can control all three machines. The conveying machine 3A and the conveying machine 3B can be controlled by a single controller for more reliable and collaborative operation.

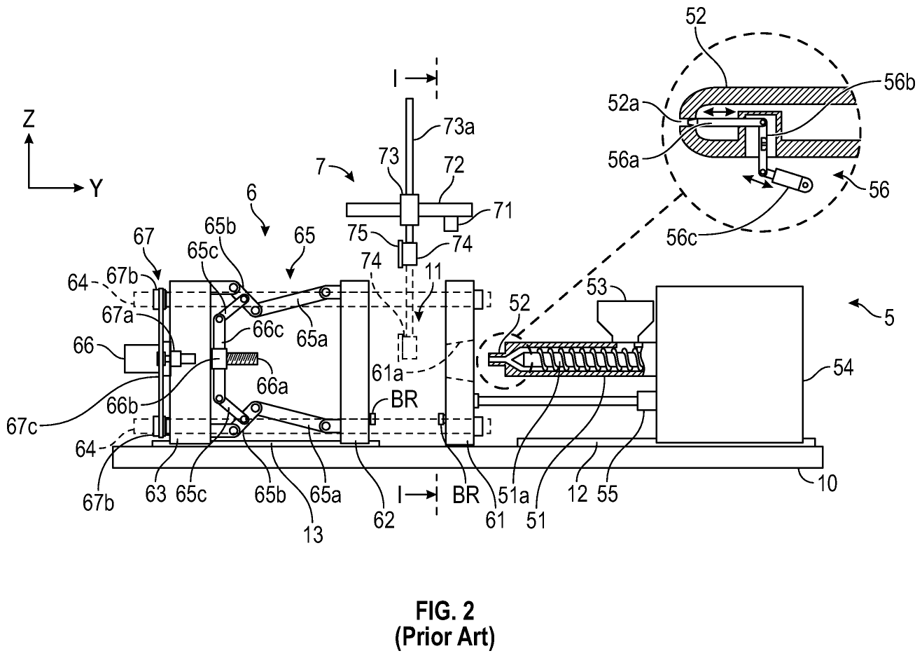

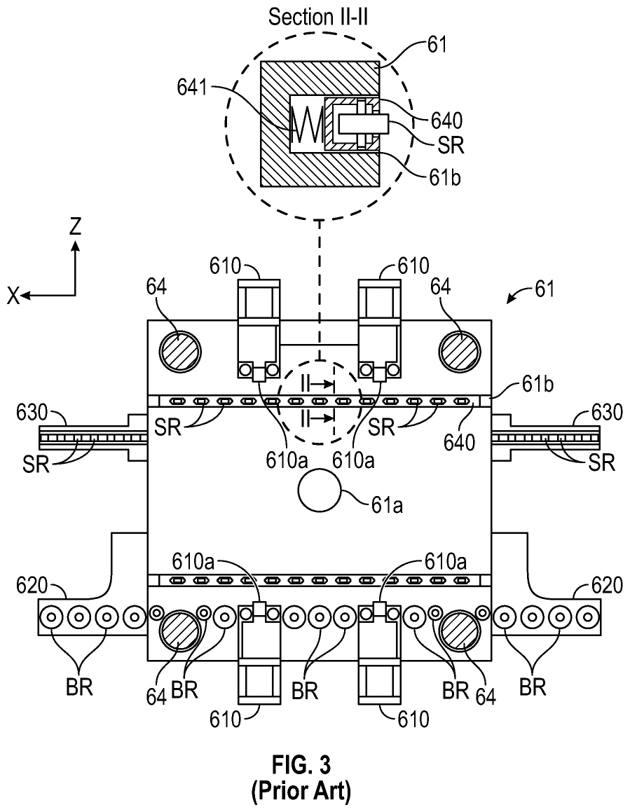

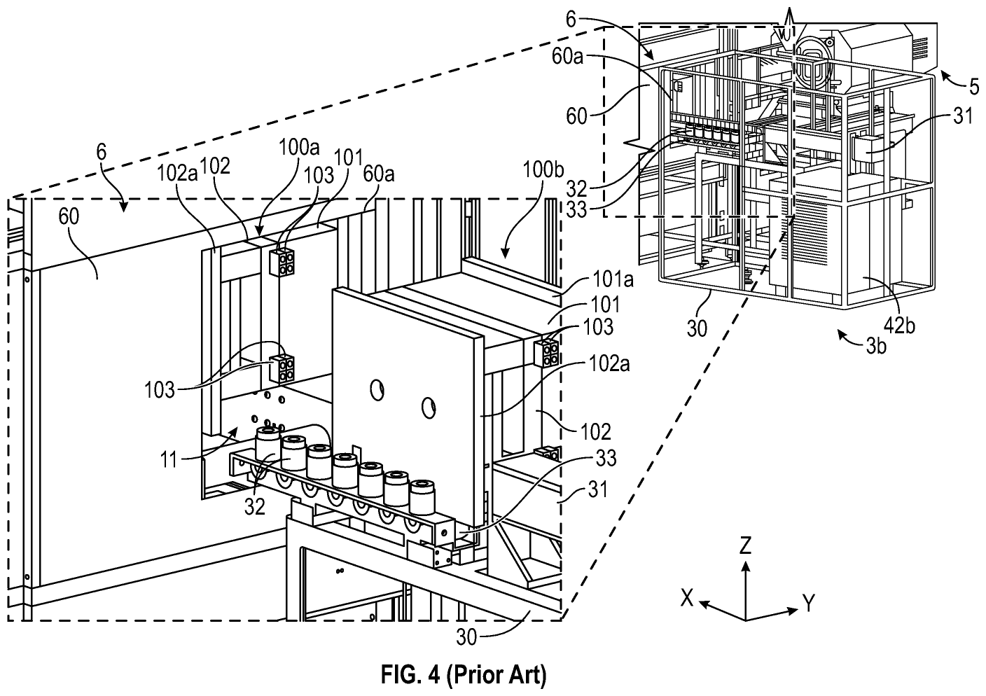

FIG. 2 illustrates a side view of the injection molding machine 2. FIG. 3 illustrates an end view of a fixed platen 61, and a figure viewing from the arrow direction of the I-I line in FIG. 2. FIG. 4 illustrates a partial perspective view for describing the configuration of a periphery of the molding operation position 11.

With reference to FIG. 1 and FIG. 2, the injection molding machine 2 includes an injecting apparatus 5, a clamping apparatus 6, and a take-out robot 7 for ejecting a molded part. The injecting apparatus 5 and the clamping apparatus 6 are arranged on a frame 10 in the Y-axis direction.

The injecting apparatus 5 includes an injection cylinder 51 that is arranged to extend in the Y-axis direction. The injection cylinder 51 includes a heating device (not illustrated) such as a band heater, and melts a resin introduced from a hopper 53. A screw 51a is integrated into the injection cylinder 51, and by rotation of the screw 51a, plasticizing and measuring the resin introduced into the injection cylinder 51 are performed, and by movement in the axial direction (Y-axis direction) of the screw 51a, it is possible to inject a molten resin from an injection nozzle 52.

In FIG. 2, an example of a shut-off nozzle as the nozzle 52 is illustrated. For an opening/closing mechanism 56 of FIG. 2, a pin 56a for opening/closing the discharge port 52a is arranged. The pin 56a is connected with an actuator (a cylinder) 56c via a link 56b, and by the operation of the actuator 56c the discharge port 52a is opened and closed.

The injection cylinder 51 is supported by a driving unit 54. In the driving unit 54, a motor for plasticizing and measuring the resin by rotationally drive the screw 51a, and a motor for driving the screw 51a to move forward/backward in the axial direction are arranged. The driving unit 54 can move forward/backward in the Y-axis direction along a rail 12 on the frame 10, and in the driving unit 54, an actuator (for example, an electrically driven cylinder) 55 for causing the injecting apparatus 5 to move forward/backward in the Y-axis direction is arranged.

The clamping apparatus 6 performs a clamping and opening and closing of the molds 100A/100B. In the clamping apparatus 6, the following are arranged in order in the Y-axis direction: the fixed platen 61, a movable platen 62, and a movable platen 63. Through platens 61 to 63, a plurality of tie-bars 64 pass. Each of the tie-bars 64 is an axis that extends in the Y-axis direction, one end of which is fixed to the fixed platen 61. Each of the tie-bars 64 is inserted into a respective through hole formed in the movable platen 62. The other end of each of the tie-bars 64 is fixed to the movable platen 63 through an adjusting mechanism 67. The movable platens 62 and 63 can move in the Y-axis direction along a rail 13 on the frame 10, and the fixed platen 61 is fixed to the frame 10.

A toggle mechanism 65 is arranged between the movable platen 62 and the movable platen 63. The toggle mechanism 65 causes the movable platen 62 to move forward/backward in the Y-axis direction in relation to the movable platen 63 (in other words, in relation to the fixed platen 61). The toggle mechanism 65 includes links 65a to 65c. The link 65a is connected rotatably to the movable platen 62. The link 65b is pivotably connected to the movable platen 63. The link 65a and the link 65b are pivotably connected to each other. The link 65c and the link 65b are pivotably connected to each other. The link 65c is pivotably connected to an arm 66c.

The arm 66c is fixed on a ball nut 66b. The ball nut 66b engages a ball screw shaft 66a that extends in the Y-axis direction, and moves forward/backward in the Y-axis direction by rotation of the ball screw shaft 66a. The ball screw shaft 66a is supported such that it is free to rotate by the movable platen 63, and a motor 66 is supported by the movable platen 63. The motor 66 rotationally drives the ball screw shaft 66a while the rotation amount of the motor 66 is detected. Driving the motor 66 while detecting the rotation amount of the motor 66 enables clamping, opening, and closing of the mold 100A/100B.

The injection molding machine 2 includes sensors 68 for measuring a clamping force, where each sensor 68 is, for example, a strain gauge provided on the tie-bar 64, and calculates a clamping force by detecting a distortion of the tie-bar 64.

The adjusting mechanism 67 includes nuts 67b supported to freely rotate on the movable platen 63, motors 67a as driving sources, and transfer mechanisms for transferring the driving force of the motors 67a to the nuts 67b. Each of the tie-bars 64 passes through a hole formed in the movable platen 63, and engages with the nut 67b. By causing the nuts 67b to rotate, the engagement positions in the Y-axis direction between the nuts 67b and the tie-bars 64 change. That is, the position at which the movable platen 63 is fixed in relation to the tie-bar 64 changes. With this, it is possible to cause a space between the movable platen 63 and the fixed platen 61 to change, and thereby it is possible to adjust a clamping force or the like.

The molding operation position 11 is a region between the fixed platen 61 and the movable platen 62.

The mold 100A/100B introduced into the molding operation position 11 are sandwiched between the fixed platen 61 and the movable platen 62 and thereby clamped. Opening and closing in based on movement of the movable mold 102 by movement of the movable platen 62 is performed.

FIG. 3 illustrates an opening portion 61a in a central portion of the fixed platen 61 through which the nozzle 52 moves forward/backward. To the surface on the side of the movable platen 62 (called an inner surface) of the fixed platen 61 a plurality of rollers BR are supported such that they are free to rotate. The plurality of rollers BR rotate around the axis of revolution in the Y-axis direction, and cause movement in the X-axis direction of the mold 100A/100B to be smooth, supporting the bottom surfaces (the bottom surface of the clamping plate 101a) of the mold 100A/100B and supporting the mold 100A/100B from below. On both sides in the X-axis direction of the fixed platen 61, a roller supporting body 620 is fixed, and the plurality of rollers BR are supported by the roller supporting body 620.

On the inner surface of the fixed platen 61, grooves 61b that extend in the X-axis direction are formed.

The grooves 61b are formed in two rows separated vertically. On each of the grooves 61b a roller unit 640 is arranged. For the roller unit 640, a plurality of rollers SR are supported such that they are free to rotate. The plurality of rollers SR rotate around the axis of revolution in the Z-axis direction, and guide movement in the X-axis direction of the mold 100A/100B contacting the outer surfaces of the mold 100A/100B (the outer surface of the clamping plate 101a) and supporting the mold 100A/100B from the side. As illustrated in the cross sectional view of the line II-II, while the roller unit 640, by a bias of a spring 641, is positioned at a position at which the roller SR protrudes from the groove 61b, at a time of clamping it is retracted in the groove 61b, and positioned at a position at which the roller SR does not protrude from the groove 61b. The roller unit 640 can prevent the inner surfaces of the mold 100A/100B and the fixed platen 61 from contacting and damaging the inner surfaces at a time of alternating the mold 100A/100B, and the roller unit 640 does not impede the inner surface of the fixed platen 61 and the mold 100A/100B being closed at a time of clamping.

On both sides in the X-axis direction of the fixed platen 61, a roller supporting body 630 is fixed, and a plurality of rollers SR are supported by the roller supporting body 630.

On the fixed platen 61, a plurality of fixing mechanisms (clamps) 610 are arranged for fixing the fixed mold 101 to the fixed platen 61. Each fixing mechanism 610 includes an engaging portion 610a that engages with the clamping plate 101a, and a built-in actuator (not illustrated) that moves the engaging portion 610a between an engagement position and an engagement release position.

Note that for the movable platen 62, similarly to the fixed platen 61, a plurality of rollers BR, the roller supporting bodies 620 and 630, the roller unit 640, and the fixing mechanism 610 for fixing the movable mold 102 are arranged.

As illustrated in FIG. 4, the periphery of the clamping apparatus 6 is surrounded by a cover (exterior covering plate) 60 for safety, but openings 60a through which the mold 100A/100B pass are formed on the sides of the molding operation position 11 for alternating the mold 100A/100B. Each opening 60a is typically continuously open, enabling free removal and insertion of the mold 100A/100B from and to the molding operation position 11.

Returning to FIG. 2, the take-out robot 7 will now be described. The take-out robot 7 includes a rail 71 that extends in the X-axis direction, and a movable rail 72 that can move in the X-axis direction on the rail 71. The movable rail 72 is arranged to extend in the Y-axis direction, and a slider 73 is arranged on the movable rail 72. The slider 73 moves in the Y-axis direction guided by the movable rail 72, and moves up and down an elevating shaft 73a in the Z-axis direction. On a lower end of the elevating shaft 73a, a vacuum head 74 is arranged, and on the vacuum head 74, a chuck plate 75 specialized to a molded part is mounted.

The take-out robot 7, after opening, moves the vacuum head 74 between the fixed mold 101 and the movable mold 102 as illustrated by broken lines in FIG. 2 by the rail 71, the movable rail 7, and the slider 73, sticks to the molded part, and conveys it outside the mold 100A/100B.

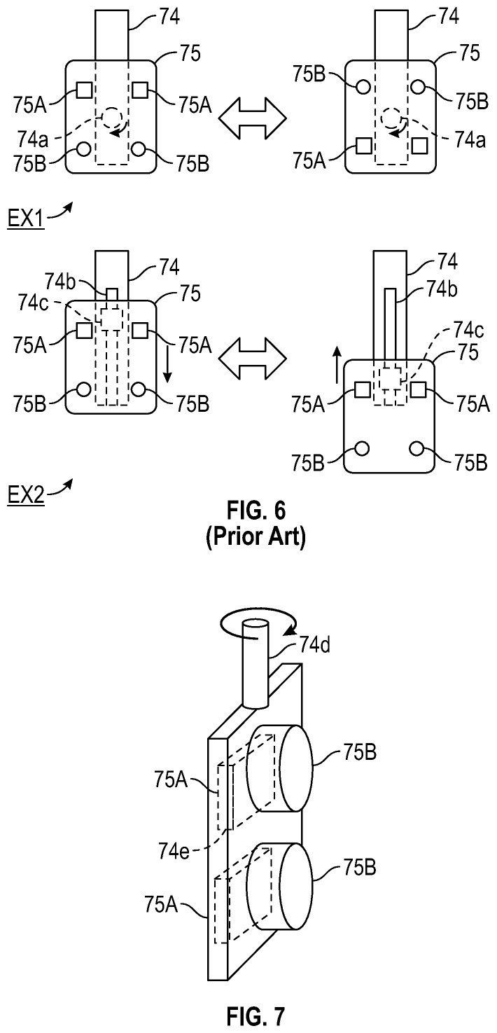

FIG. 6 is being provided herein for information/description purposes only. EX1 of FIG. 6 indicates an example of the chuck plate 75. The chuck plate 75 includes a holding portion 75A and a holding portion 75B. The vacuum head 74 causes the chuck plate 75 to rotate around an axis 74a, and causes the chuck plate 75 to be displaced so that the positions of the holding portion 75A and the holding portion 75B change. This provides for switching the holding portion facing the molded part, handling different molded parts in a short time without replacing the chuck plate 75. EX2 of FIG. 6 illustrates another example of the chuck plate 75. The chuck plate 75 includes a holding portion 75A and the holding portion 75B. The vacuum head 74 includes a rail 74b and a slider 74c that moves along the rail 74b, and the chuck plate 75 is arranged on the slider 74c. Moving the slider 74c results in the chuck plate 75 being displaced to change the positions of the holding portion 75A and the holding portion 75B. This provides for switching the holding portion facing the molded part handling different molded parts in a short time without replacing the chuck plate 75.

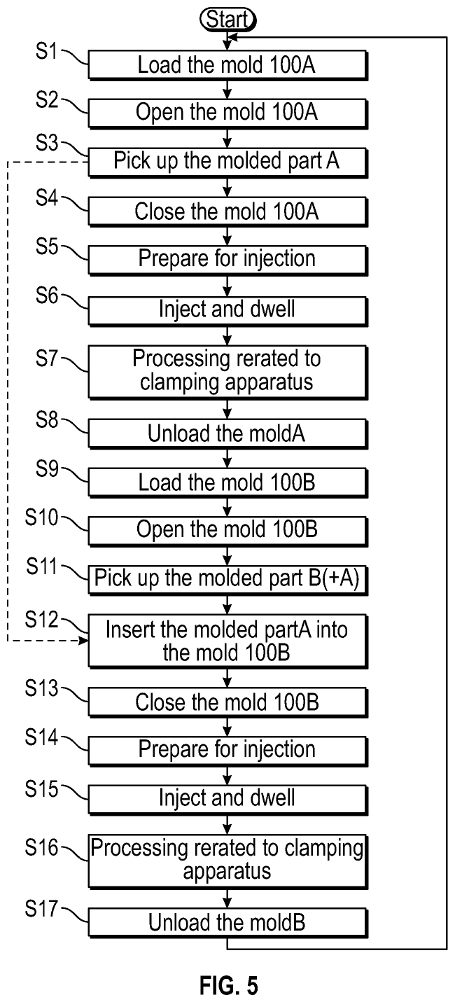

FIG. 5 is a flowchart illustrating an example of a control method of the injection molding system 1 executed by the controller 41.

In the following example, a case in which a molding operation is performed while alternating the molds 100A and 100B in the following manner: molding using the mold 100A→molding using the mold 100B→molding using the mold 100A, etc., is envisioned. However, a molded part A molded in the mold 100A is placed in the mold 100B when the mold 100B is open. Then, a resin is injected in the mold 100B containing the molded part A, and a molded part B united with the molded part A is manufactured.

At the beginning of this processing flow, the mold 100B with resin injected has been unloaded from the injection molding machine 2 to the conveyance machine 3B. The following description describes the processes that follow this step. In step S1 of FIG. 5, the cooled mold 100A is loaded into the injection molding machine 2. The mold A includes the molded part A that was made from the resin injected in the previous cycle and then hardened in the cooling process. In step S2, the motor 66 is driven to move the movable platen 62 away from the stationary platen 61. The stationary mold 101 is fixed to the stationary platen 61 by the fixing mechanisms 610, and the movable mold 102 is fixed to the movable platen 62 by the fixing mechanisms 610. Thus, the movable mold 102 separates from the stationary mold 101 and the mold 100A is opened.

In step S3, the take-out robot 7 drives the holding portion 75A to remove the molded part A, remaining on the side of the movable mold 102 of the mold 100A. The molded part A that is removed continues to be held by the holding portion 75A until the process of step S12.

In step S4, the clamping device 6 drives the motor 66 to drive the toggle mechanism 65 to perform clamping of the mold 100A with the stationary platen 61 and the movable platen 62.

In step S5, the preparation for injection to the mold 100 A is performed by the injecting machine 5. The injecting machine 5 drives the actuator 55 to move the injection machine 5 to move the nozzle 52 such that it contacts the mold 100A.

In step S6, injection and dwelling of molten resin is performed. The injection machine 5 is driven to fill molten resin into a cavity in the mold 100A from the nozzle 52, and to press the resin into the mold 100A at a high pressure in order to compensate for a volume decrease due to resin solidifying. The actual clamping force is measured by the sensor 68 during the processing of step S6. During molding, the mold 100A thermally expands due to the temperature of the mold 100A gradually rising. There are cases where a difference arises in the initial clamping force and the clamping force after a period of time has passed. Accordingly, it is possible to correct the clamping force at the time of the next clamping based on a result of measurement by the sensors 68.

The adjustment of the clamping force is performed by an adjustment of the position of the movable platen 63 in relation to the tie-bar 64 by driving the motor 67. This enables enhance precision of the clamping force by adjusting the clamping force by correcting the initial value of the position of the movable platen 63 in relation to the tie-bars 64 based on the result of measurement by the sensors 68. The adjustment of the position of the movable platen 63 in relation to the tie-bars 64 can be performed at any timing (for example, step S6, step S7, steps S13-S15 in the flowchart of FIG. 5).

In step S7, processing related to the clamping device 6 is performed. First, locking of the mold 100A by the fixation mechanisms 610 is released. The motor 66 is driven to drive the toggle mechanism 65. This results in removal of the clamping force, the movable platen 62 separates slightly in relation to the stationary platen 61, and a space in which it is possible to alternate the molds 100A and 100B is formed.

In step S8, the mold 100A is unloaded or ejected from the molding operation position 11 to the conveying machine 3A. After the mold 100A is ejected from the molding operation position 11, the mold 100A is cooled to the appropriate temperature during for predetermined time period. A mold typically includes a channel running inside the mold, a temperature controller is connected, via a hose, to the interface of the channel formed on a surface of the mold, while the mold is prepared for injection molding. The fluid at a certain temperature flows from the temperature controller inside the mold, to keep the mold at a certain temperature. During the injection molding processes, including the cooling process, fluid is usually always running inside the mold.

Typically, after step S8, the mold 100A is still heated up from the melted resin injected into the mold 100A. In the cooling process by the fluid from the temperature controller, the temperature is dropped to a predefined temperature, for example 60 degrees Celsius. The cooling process continues until a predetermined time period passes from the start of the cooling process.

In some injection molding processes like heat and cool molding, the cooling process includes a dedicated temperature controller to cool down a mold to a certain temperature, which is different from a temperature at which a mold receives the melted resin from an injecting machine.

In step S9, the mold 100B is loaded from the conveying machine 3B to the molding operation position 11. In step S10, the movable platen 62 is separated from the fixed platen 61 by driving the motor 66. The stationary mold 101 is fixed to the stationary platen 61 by the fixing mechanisms 610, and the movable mold 102 is fixed to the movable platen 62 by the fixing mechanisms 610. Therefore the movable mold 102 separates from the stationary mold 101 and the mold 100B is opened against the force of the self-closing unit 103. In step S11, the molded part B, which is united with molded part A, remaining on the side of the movable mold 102 of the mold 100B is removed by driving the take-out robot 7 and using the holding portion 75B is conveyed outside the injection molding machine 2.

In step S12, the molded part A being held by the holding portion 75A is placed in the metal mold B. In step S13, clamping of the mold 100B is performed. In step S14, preparation for injection to the mold 100B is performed by driving the actuator 55 to move the injection machine 5. This causes the nozzle 52 to contact the mold 100B.

In step S15, injection and dwelling of molten resin is performed. In step S16, processing related to the clamping device 6 is performed, which is the same process as in step S7. In step S17, the mold 100B is unloaded from the molding operation position 11 to the conveying machine 3B.

As described above, in the present embodiment, cooling of the mold 100A/100B is performed on the conveying machines 3A or 3B outside the injection molding machine 2. Also, during cooling of one of the molds 100A or 100B, each process of molded part ejection→clamping→injection/dwelling is performed by the injection molding machine 2 for the other of the mold 100A or 100B. Since opening and molded part ejection are performed by the injection molding machine 2, the conveying machines 3A and 3B do not need to include a function for opening and a function for molded part ejection.

Accordingly, it is possible to manufacture the molded part B united with molded part A while alternating the multiple molds 100A and 100B by one injection molding machine 2 while avoiding cost increases to the injection molding system 1. Because the injection molding system 2 molds a molded part B following the molding of a molded part A, it is not necessary to manufacture a large quantity of molded part A beforehand. Thus, it is possible to decrease the risk of storing excess inventory of molded part A.

FIG. 7 is an illustrative view of a chuck plate of another exemplary embodiment. FIG. 7 illustrates the chuck plate 74e connected to the tip of the axis 74d. The chuck plate 74e includes several holding portions 75A on one surface and several holding portions 75B on another surface. It is possible to switch the holding portion facing the molded part by rotating the chuck plate 74e around an axis 74d. The rotation angle is not limited to 180 degree. Any angle that enables the holding portion to properly catch and hold the molded part is applicable.

The take-out robot 7 can include a robotic hand that can hold both molded part A and molded part B. In the above-described embodiment, e the take-out robot 7 keeps holding the molded part after the take-out robot 7 has removed the molded part from the first mold until the take-out robot 7 places the molded part in the second mold. In another exemplary embodiment, the take-out robot 7 can place the molded part on a table (not illustrated) temporarily provided near the molding operation position 11.

If it is necessary to sufficiently cool down the molded part A before it is placed in the mold 100B, the molded part A can be cooled on the table while one or more cycles of changing the molds pass. In this case, it is better to enable putting the molded parts A on the table for longer than the number of cycles necessary to cool them. This enables using a molded part A that was molded one or more previous exchange cycles as the molded part to place in the mold 100B.

A sensor (not illustrated) can be installed in the mold to enable detecting that the molded part A was placed in the mold 100B. A pressure sensor or optical sensor can be used. An image of the placement condition can be captured using a camera installed in the vicinity of the molding operation position 11, where the captured image is used to judge placement. The sensor for detecting that the molded part A is placed in the mold 100B can be located in other positions in the injection molding machine 2 other than the mold 100A/100B and the take-out robot 7.

In another exemplary embodiment, a table can be provided to adjust the holding orientation of the molded part A held by the take-out robot 7. Repositioning of the molded part A can also occur on the table. A sensor (image sensor, etc.) (not illustrated) installed in the vicinity of the table or on the take-out robot 7 to can be used to change the hold to an accurate orientation to place the molded part in the mold 100B.

In an exemplary embodiment of the injection molding system 1, an inspection process is conducted to ensure that a molded part is considered to be acceptable A molded part is considered to be acceptable, for example, if there are no detected abnormalities, etc. either on the surface of the mold or within the internal structure of the mold.

The inspection process can include, for example, an image capturing device located in the injection molding machine 2 that captures an image of the external appearance the molded part. The molded part is checked with respect to the surface condition and the shape of the molded part based on the captured image. The molded part can also be checked with respect to the color of the molded part based on the captured image.

An image capturing device that captures an internal structure of the molded part using radiation, such as X-ray, can also be used for the checking process. In a case where the checking process for the molded part B is performed outside the injection molding machine 2, the checking process for the molded part A performed in the injection molding machine 2 can be just the external appearance inspection.

In the inspection process, the molded part A is removed by the take-out robot 7, one or more image capturing devices controlled by the control device 4 capture an image with the appearance of the molded part A in a state where the molded part A is held by the take-out robot 7. The captured image is analyzed by the control device 4, and a result indicating whether the molded part A is an accepted part is provided. In another embodiment, the captured image can be analyzed by components other than the control device 4.

In another embodiment, the molded part A removed by the take-out robot 7 can be placed at a predetermined position outside the injection molding machine 2, where the inspection process for the molded part A can be performed. In this case, the take-out robot 7 does not maintain a hold on the molded part A during a period from when the take-out robot 7 removes the molded part A from the mold 100A to when the take-out robot 7 places the molded part A in the mold 100B.

In the event that the molded part A is deemed not accepted, there are various options that can be followed. In one option, the mold 100A is not moved from the molding operation position 11 in the injection molding machine 2, and the injection molding using the mold 100A is repeated. In a case where the mold 100A has already been moved from the injection molding machine 2 before the inspection process is performed, the mold 100A is moved to the injection molding machine 2 again, and the injection molding using the mold 100A is repeated. The molded part A is then re-checked. If the molded part A is determined to be an accepted part, the molded part A is placed in the mold 100B. If the molded part A is determined as the accepted part, the mold 100A is moved from the injection molding machine 2 and the mold 100B is moved in the injection molding machine 2 as usual.

In a second option, another accepted part is prepared outside the injection molding machine 2 in advance, while the prepared molded part A is held by the take-out robot 7, and used instead of a non-accepted part. In this case, based on the determination indicating that the molded part A is a non-accepted part, the control device 4 controls the take-out robot 7 to release the non-accepted part so that the non-accepted part can be disposed of. The prepared molded part A is held by take-out robot 7 and placed in the mold 100B. If the molded part A is determined to be an accepted part, the molded part A that was just removed by take-out robot 7 from the mold 100A is placed in the mold 100B as usual.

In a third option, the take-out robot 7 places the molded part A at a predetermined position outside the injection molding machine 2. In this case, after placing the molded part A at the predetermined position, the take-out robot 7 holds another molded part A determined as an accepted part and places it in the mold 100B. This flow is effective where a time required to check the molded part A is relatively long.

The process associated with each of the above-described options are pre-installed in the control device 4. The injection molding machine 2 selects, based on, for example, a user's inputs, one of the processes.

In a case where the molded part A is not an accepted part, the molded part B including the molded part A is not an accepted part as well. The molded part A should be inspected to determine whether it is an accepted part before the molded part A is placed in the mold 100B.

In the above-described second option, it is preferable to only produce some molded parts A in advance. That is, the mold 100A is placed at the molding operation position 11 and the injection molding is performed until a predetermined number, for example 10, of accepted parts A is produced. The injection molding machine 2 operates in a mode where the injection molding only uses the mold 100A. In a case where the predetermined number of accepted parts A is produced, the injection molding machine 2 enters a mode where the injection molding alternately uses the mold 100A and the mold 100B. The mode where the injection molding uses only the mold 100A can also be adopted in the above-described third option.

In the injection molding process after the molded part A is determined to be a non-accepted part in the above-described first option, and the injection molding process for producing the predetermined number of the molded parts A in advance, it is not necessary to cool the mold 100A at a position other than the molding operation position 11. In other words, it is not necessary to cool the mold 100A by moving the mold 100A out of the injection molding machine 2. There is, however, a difference between a pressure applied to the mold where the mold is cooled on the conveying machines 3A or 3B and a pressure applied to the mold where the mold is cooled at the molding operation position 11 in the injection molding machine 2. Thus, the quality of the mold can differ between these two situations.

In the above injection molding processes, the mold 100A can be cooled where the mold 100A is moved from the molding operation position 11. The mold 100A can also be cooled where the mold 100A is at the molding operation position 11 and the platens 61, 62 can be separated from the mold 100A. This makes the pressure applied to the mold 100A similar to that where the mold 100A is cooled on the conveying machines 3A or 3B.

According to an embodiment, multiple take-out robots 7 can be installed. For example, a robot A (not illustrated) is used to remove the molded part A from the mold 100A and to place the molded part A in the mold 100B. A robot B (not illustrated) can be used to remove the molded part B from the mold 100B. In this case, because the robot A only has to be able to operate in the vicinity of the molding operation position 11, it can be installed, for example, below the vicinity of the molding operation position 11, and can have a smaller operating area than the robot B. In this configuration, it may be necessary for the robot B to be of a size enabling transfer of the removed molded part B outside the injection molding machine 2.

While the above-described embodiments have referenced the use of two molds, the number of molds is not limited to two. The above-described embodiments enable alternating between multiple molds while performing injection molding.

While the above described-embodiments have described performing, clamping, injection/dwelling, opening, and ejection where the mold is at the molding operation position 11, this is not seen to be limiting. All processes do not need to be performed at the molding operation position 11. Some of the processes can be performed at a position different from the molding operation position 11. For example, after a cooling process of a mold, the mold is conveyed to a predetermined position in the injection molding machine 2, which is different from the molding operation position 11. The molded part can be removed at the predetermined position. The mold can then be conveyed from the predetermined position to the molding operation position 11.

While the above-described embodiments discussed that the cooling process is performed where the mold is on the conveying machines 3A or 3B and is external to the injection molding machine 2, this is not seen to be limiting. The cooling process can be performed at a position where the mold does not contact the fixed platen 61 and the movable platen 62. For example, the cooling process can be performed where a part of the mold is in the injection molding machine 2 and another part of the mold is outside the injection molding machine 2. Where a configuration that a part of the conveying machine 3A or 3B is located in the injection molding machine 2 is used, the cooling process can be performed where a part of the mold is in the injection molding machine 2 and another part of the mold is on either the conveying machine 3A or 3B.

Definitions

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Combinations of any exemplary embodiments disclosed above are also included as embodiments of the present disclosure. While the above-described exemplary embodiments discuss illustrative embodiments, these embodiments are not seen to be limiting.

What is claimed is:

1. A method for manufacturing a molded part using one injection molding machine while changing between multiple molds, the method comprising:
a first step of performing, at a molding operation position in the injection molding machine, clamping, injection, and dwelling of a mold;
a second step of conveying the mold from the molding operation position and performing a process of cooling the mold at a position different from the molding operation position; and
a third step of conveying the mold to the molding operation position, opening the mold, and ejecting a molded part from the mold,
wherein, before performing the first step for a first mold, a molded part previously ejected from a second mold is placed into the first mold opened in the third step.

2. The method according to claim 1, wherein, in the third step, the molded part is removed by a take-out robot, wherein the take-out robot is configured to remove a molded part molded by the first mold and a molded part molded by the second mold.

3. The method according to claim 2, wherein the take-out robot includes a first holding portion for removing a molded part from the first mold and a second holding portion for removing a molded part from the second mold.

4. The method according to claim 3, wherein the first holding portion or the second holding portion include a mechanism that secures the molded part via a vacuuming force.

5. The method according to claim 1, wherein, in the third step, a molded part is removed by a take-out robot, wherein the take-out robot maintains a hold on the molded part after removing the molded part from the first mold in the third step until the take-out robot places the molded part in the second mold.

6. The method according to claim 1, wherein, in the third step, a take-out robot removes a molded part from the first mold and places the molded part on a structure external to the injection molding machine before placing the molded part into the second mold.

7. An injection molding system comprising:
a injection molding machine;
a first conveyance machine configured to convey a mold;
a second conveying machine configured to convey a mold;
and a control apparatus,
wherein the control apparatus is configured to control:
a first step of, at a molding operation position in the injection molding machine, clamping a mold, injecting the mold, and dwelling the mold;
a second step, of conveying, via the first conveyance machine or the second conveyance machine, the mold from the molding operation position to a different position, wherein cooling of the mold occurs at the different position; and
a third step of conveying the mold to a predetermined position via the first conveyance machine or the second conveyance machine, opening the mold, and ejecting a molded part,
wherein, before performing the first step for a first mold, the molded part previously ejected from a second mold is placed into the first mold opened in the third step.

8. The injection molding system according to claim 7, further comprising a take-out robot configured to remove the molded part from the mold, wherein the take-out robot is configured to remove a molded part molded by the first mold and a molded part molded by the second mold.

9. The injection molding system according to claim 8, wherein the take-out robot includes a first holding portion to remove the molded part from the first mold and a second holding portion to remove the molded part from the second mold.

10. The injection molding system according to claim 9, wherein the first holding portion or the second holding portion include a mechanism that secures the molded part via a vacuuming force.

11. The injection molding system according to claim 7, wherein, in the third step, a molded part is removed by a take-out robot, wherein the take-out robot maintains a hold on the molded part after removing the molded part from the first mold until the take-out robot places the molded part into the second mold.

12. The injection molding system according to claim 7, wherein, in the third step, a take-out robot removes a molded part from the first mold and places the molded part on a structure external to the ejection molding machine before placing the molded part into the second mold.

13. A method for manufacturing a molded part using one injection molding machine while changing between multiple molds, the method comprising:
a first step of, at a molding operation position in the injection molding machine, performing mold clamping, injection, and dwelling of a mold;
a second step of conveying the mold out of the molding operation position and performing cooling of the mold at a position different from the molding operation position; and
a third step of conveying the mold into a predetermined position in the injection molding machine, performing opening of the mold, and performing ejection of a molded part,
wherein, before performing the first step for a first mold, the molded part previously ejected from a second mold is placed into the first mold opened in the third step.
